(19) United States
(12) Patent Application Publication
(10) Pub. No.: US 2010/0114678 A1
(43) Pub. Date: May 6, 2010

(54) Compensation Distribution Using Quality Score

(75) Inventors: Brian Axe, Portola Valley, CA (US); Ronald Ho, Fremont, CA (US); Amit Paunikar, Los Angeles, CA (US); Christian Oestlien, San Francisco, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/497,120

(22) Filed: Jul. 2, 2009

Related U.S. Application Data
(60) Provisional application No. 61/111,576, filed on Nov. 5, 2008.

(51) Int. Cl. G06Q 30/00; G06Q 10/00; G06Q 20/00

(52) U.S. Cl. 705/14.1; 705/14.41; 705/14.7; 705/14.71; 705/34; 705/39

(57) ABSTRACT

Among other disclosed subject matter, a computer-implemented method for compensation distribution includes analyzing first content from a publisher with regard to a quality criterion. The method includes associating the first content with a quality score based on the analysis. The method includes providing second content to the publisher to be published with the first content. The method includes distributing a compensation to the publisher relating to the second content, the compensation based at least in part on the quality score.

### CROSS-REFERENCE TO RELATED APPLICATIONS

This application is a utility patent application and claims priority to U.S. Provisional Application Ser. No. 61/111,576, filed on Nov. 5, 2008, the entire contents of which are incorporated herein by reference.

### TECHNICAL FIELD

This document relates to content presentation.

### BACKGROUND

Today's computer systems offer several ways of distributing content. Content creators who are also publishers can include their content in a suitable publication medium (e.g., on an internet page) to make it available to online viewers. Content creators may also or instead seek to have others publish their content. Publishers sometimes publish content of others for free and sometimes do it in return for payment from the content creator. Online advertising is an example of the latter.

A multitude of publishers make use of computer networks such as the internet for publication, and their respective publications can have unique characteristics and/or qualities. Often, a page from one publisher can be significantly different from that of another, and so on. Differences can be due to deliberate design choices stemming from the publisher's intention and vision behind the publishing; in other situations, they can be the result of cost restrictions, lack of artistic creativity and/or a limited understanding of the technology involved in the publishing medium.

### SUMMARY

The invention relates to compensation distribution.

In a first aspect, a computer-implemented method for compensation distribution includes analyzing first content from a publisher with regard to a quality criterion. The method includes associating the first content with a quality score based on the analysis. The method includes providing second content to the publisher to be published with the first content. The method includes distributing a compensation to the publisher relating to the second content, the compensation based at least in part on the quality score.

Implementations can include any, all or none of the following features. An advertiser can provide the second content for forwarding to the publisher, and the method can further include collecting a fee from the advertiser for publishing the second content, wherein distributing the compensation to the publisher includes sharing a portion of the fee with the publisher based on the quality score. The method can further include determining the fee to be collected from the advertiser, the fee determined based at least in part on the quality score. A content distributing entity can forward the second content to the publisher and distribute the compensation, and distributing the compensation can include that the content distributing entity gains a higher sum compared to an equivalent publication by another publisher associated with a higher quality score that the publisher. The method can further include sharing at least part of the higher sum with an advertiser who pays to have the second content published. The method can further include sharing at least part of the higher sum with the other publisher having the higher quality score. The method can further include again analyzing the first content with regard to the quality criterion; and associating the first content with a new quality score based on again analyzing the first content. The method can further include informing the publisher, before the first content is again analyzed, about a quality of the first content; and comparing the new quality score with the quality score to determine whether the quality has improved. The first content can be associated with the new quality score every n time units and the new quality score can be based on analyses of the first content over a past N time units, wherein n and N are positive numbers. The second content can be forwarded to the publisher in real time for publication, and the method can further include recording information about the first content, second content and the quality score in connection with forwarding the second content; and determining the compensation based on the recorded information, the compensation determined subsequently and substantially not in real time. The method can further include conducting an auction for the publication of the second content with the first content, wherein the compensation is based also on an outcome of the auction. The auction can be arranged so that a plurality of publishers compete for rights to publish the second content. Analyzing the first content can include training a classifier module to perform analysis regarding at least the quality criterion; and identifying the first content to the classifier module to perform the analysis.

In a second aspect, a computer program product is tangibly embodied in a computer-readable storage medium and includes instructions that when executed by a processor perform a method for compensation distribution. The method includes analyzing first content from a publisher with regard to a quality criterion. The method includes associating the first content with a quality score based on the analysis. The method includes forwarding second content to the publisher to be published with the first content. The method includes distributing a compensation to the publisher relating to the second content, the compensation based at least in part on the quality score.

In a third aspect, a computer system includes a repository including quality scores for respective first contents associated with publishers, the quality scores determined by analyzing the first content with regard to a quality criterion. The system includes a content distribution module that forwards second content to at least a first one of the publishers to be published with at least one of the first contents. The system includes a compensation distribution module that distributes a compensation to the first publisher relating to the second content, the compensation based at least in part on the quality score of the first publisher.

In a fourth aspect, a computer-implemented method for compensation distribution includes analyzing a first page from a publisher with regard to a quality criterion, the publisher having agreed to include at least one advertisement on the page in return for compensation. The method includes associating the first page with a quality score based on the analysis, the quality score indicating a quality of the page as defined by an advertisement serving entity who serves at least the advertisement to the publisher. The method includes obtaining at least the advertisement from an advertiser who has agreed to pay a fee for publication of the advertisement. The method includes forwarding at least the advertisement to the publisher to be published on the first page, the advertisement selected by the advertisement serving entity. The method includes distributing a payment to the publisher relating to the advertisement, the payment being calculated based at least in part on the fee received from the advertiser and the quality score, wherein a remainder of the fee is at least temporarily kept by the advertisement serving entity.

Implementations can include any, all or none of the following features. The method can further include sharing at least part of the remainder with the advertiser. The method can further include identifying at least one other publisher having a higher quality score than the publisher; and sharing at least part of the remainder with the other publisher.

In a fifth aspect, a method includes receiving a plurality of bids for presenting content in a publication resource. The method includes selecting at least one of the plurality of bids. The method includes determining a quality score for the publication resource substantially at a time coincident with presentation of the content in the publication resource. The method includes adjusting the selected bid based on the quality score.

In a sixth aspect, a method includes receiving a plurality of bids for presenting content in a publication resource. The method includes selecting at least one of the plurality of bids that indicates a bid amount. The method includes collecting the bid amount for the selected bid. The method includes determining a quality score for the publication resource substantially at a time coincident with presentation of the content in the publication resource. The method includes generating a refund of a portion of the bid amount based on the quality score.

Implementations can provide any, all or none of the following advantages. Distribution of content such as advertising can be managed more efficiently. Compensation distribution can be made more flexible. Automatically determined quality scores can be taken into account when compensating publishers. Publication quality can automatically be taken into account when distributing compensation.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an example system that can perform compensation distribution.

FIG. 2 depicts a flow diagram of an example process.

FIG. 3 is a block diagram of a computing system that can be used in connection with computer-implemented methods described in this document.

FIGS. 4A-B show examples of compensation distribution.

Like reference symbols in the various drawings indicate like elements.

### DETAILED DESCRIPTION

Content can be distributed over a distribution system. In some implementations the distribution system can be an electronic distribution system, such as through the Internet. Content items can be distributed and providers of the content item can compensate (i.e., pay) publishers to have their content distributed. For example, an advertiser can compensate a content publisher (e.g., a web page publisher that will include the advertiser's content on a web property of the publisher) for distribution of their respective content. Compensation can depend on many factors, for example, including quality of an associated web property. Methods, systems, apparatus, and computer readable mediums are proposed for distributing content, collecting compensation, and distributing compensation based at least partly on the analysis of published content.

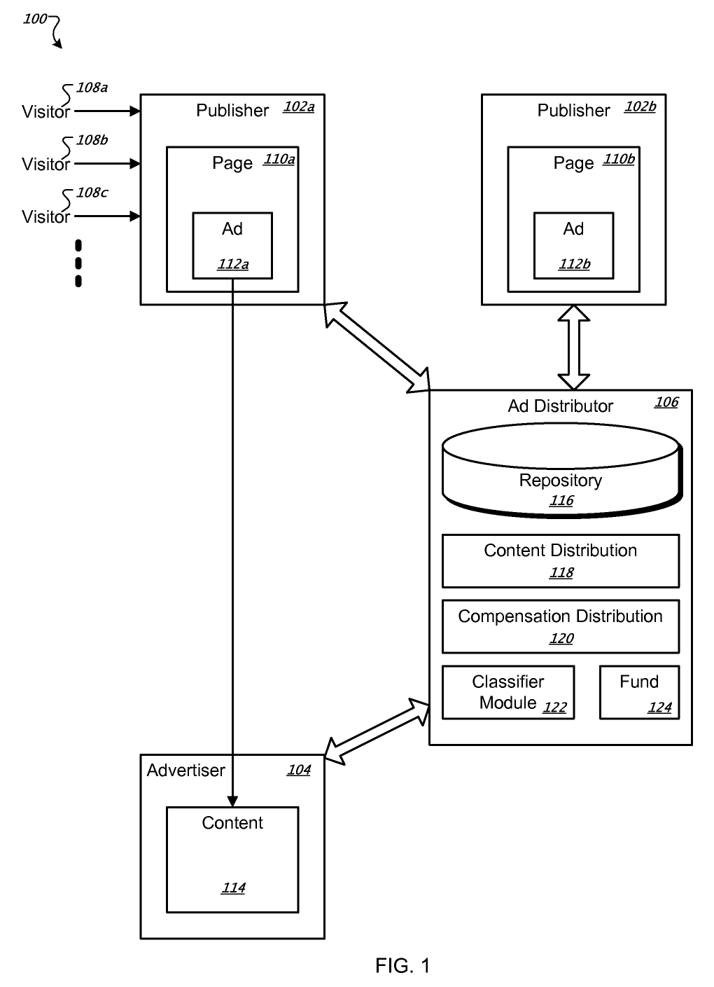

FIG. 1 is a block diagram of an example system 100 that can perform compensation distribution. The system 100 in this implementation includes a publisher 102a, a publisher 102b, at least one advertiser 104, and an ad distributor 106. The ad distributor 106 can distribute ads or any other form of content. The publishers 102a and 102b can process requests from one or more visitors, such as a visitor 108a, a visitor 108b, and/or a visitor 108c. The visitors 108a-108c can request pages or other content from the publishers, such as a page 110a and/or a page 110b. In some implementations, the pages 110a-110b can be web pages, electronic documents, news feeds, audio content, video content, or other forms of electronic data. The pages 110a and 110b can include content such as an ad 112a and an ad 112b, respectively. The ads 112a-112b can include links or banners in a web page, commercials spliced into a video or audio stream, or other form of advertising content, to name just a few examples.

When any of the ads 112a-112b is selected by a visitor, an advertising content 114 (e.g., the advertisers' 104 web page) can be served to the visitors 108a-108c. In some implementations, the publishers 102a-102b can publish the ads 112a-112b as a source of revenue. For example, the advertiser 104 can directly or indirectly provide compensation to the publishers 102a-102b based on, for example, the visitors 108a-108c selecting (e.g., click through) the ads 112a-112b

The advertiser 104 and the publishers 102a-102b can use the ad distributor 106 as an intermediary for the distribution of the ads 112a-112b and revenue. In some implementations, the advertiser 104 or another content provider can provide ads and/or other content to the ad distributor 106, and the ad distributor 106 can associate the ads 112a-112b with the publisher pages 110a-110b. For example, the ad distributor 106 can track the number of times the ads 112a-112b are selected to determine, for example, how much money the advertiser 104 can be charged for distributing the ads 112a-112b. The ad distributor 106 can also compensate the publishers 102a-102b for hosting the ads 112a-112b on the pages 110a-110b.

In some implementations, the amount of compensation given to one or more of the publishers 102a-102b can be adjusted based on a quality score. For example, a quality score can be determined using the pages 110a-110b. In some examples, the page 110a can include established facts whereas the page 110b can include controversial opinions. In this example, the page 110a can have a relatively high quality score whereas the page 100b can have a relatively low quality score. Other criteria for quality scoring can be used, and further examples will be described below. The ad distributor 106 can use the quality score as a basis to determine the compensation to be provided to the publisher 102a and the publisher 102b for publishing the ads 112a-112b.

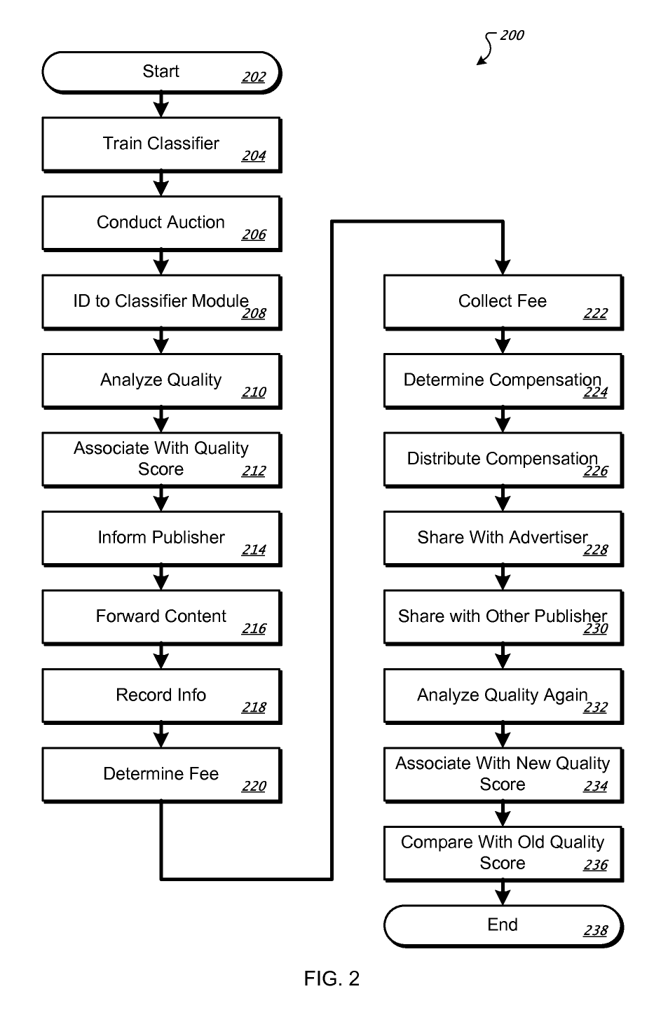

In some implementations, the ad distributor 106 can adjust the amount of money charged to the advertiser 104 based on some aspect pertaining to the publisher, such as the quality of the pages 110a-110b. For example, the page 110a may include high-quality content, whereas the page 110b may include lower-quality content. In some implementations, the ad distributor 106 can charge the advertiser 104 more money for interaction with (e.g., click-throughs of) the ad 112a than for interaction with the ad 112b. In some implementations, the ad distributor 106 can adjust both the amount of compensation given to the publishers 102a-102b and the amount of money charged to the advertiser 104 based on the quality scores of the pages 110a-110b. Examples of processes for evaluating page quality and compensation adjustment will be described below with regard to FIG. 2.

The ad distributor 106 here includes a repository 116. The repository 116 stores content, such as the ads 112a-112b or other information, obtained from content providers, such as the advertiser 104. In some implementations, the repository can include a database, an electronic file, a collection of electronic files, a list, a table, and/or other component for storing and retrieving electronic information.

A content distribution module 118 distributes content such as ads from the repository 116 to the publishers 102a-102b. In some implementations, the content distribution module 118 can track the numbers of times the ads 112a-112b have been distributed for inclusion in the pages 110a-110b, and/or the number of times that the visitors 108a-108c have interacted with (e.g., clicked-though) the ads 112a-112b. In some implementations, the content distribution module 118 can distribute the ads 112a-112b based on the content of the pages 110a-110b. For example, the publisher 102a can make a request to the ad distributor 106 for an ad to be included in the page 110a. The page 110a can be a page of travel information, and the repository 116 may include an ad (e.g., the ad 112a) for a car navigation product. The content distribution module 118 can associate the topics of “travel” and “navigation,” and deliver the ad 112a to be included in the page 110a. In some implementations, the content distribution module 118 can distribute ads based on the quality scores assigned to various pages. For example, the advertiser 104 can request that the ad distributor 106 only place its ads on pages that have been determined to be of a predetermined quality level (e.g., high quality).

A compensation distribution module 120 can manage the amount of compensation given to the publishers 102a-102b and/or the amount of money charged to the advertiser 104. A classifier module 122 can analyze the contents of the pages 110a-110b to determine their quality, and assign them a quality score. In some implementations, the classifier module 122 may determine quality scores based on one or more of the following aspects of the pages 110a-110b: authoritativeness, verifiability, entertainment value, grammatical accuracy, educational value, timeliness, aesthetic quality, originality, cohesiveness, reputation, informational value, search ranking, popularity, server responsiveness, or other quality criteria and/or combinations thereof, to name a few examples.

The compensation distribution module 120 can use the quality score associated with the respective page to adjust the amount of compensation that the publisher will be given when visitors are presented with and/or interact with (e.g., click-through or other form of conversion) the ads 112a-112b. For example, the classifier module 122 may associate a relatively high quality score with the page 110a, and a relatively low quality score with the page 110b.

The following is an example of a compensation distribution that uses fees of fifty cents and one dollar for purposes of illustration. When the visitor 108a clicks-though the ad 112a, the compensation distribution module 120 may cause the publisher 102a to be compensated one dollar. Similarly, when the visitor 108a clicks-through the ad 112b, the publisher 102b may be compensated fifty cents. This is an example of how compensation can be distributed based on a quality score. In another example, the ad distributor 106 may generally charge the advertiser 104 fifty cents per click-through, but offer a discounted rate (e.g., twenty-five cents) for click-throughs that are generated from pages with a low quality score (e.g., the page 110b).

In some implementations, the compensation distribution module 120 may withhold compensation from one transaction and use withheld funds for another purpose, such as to augment the compensation given to another page. For example, the page 110b may be determined to have a low quality score (e.g., 0.1 on a 0.0-1.0 scale) and the page 110a may have a high quality score (e.g., 1.0 on a 0.0-1.0 scale). In this example, the ad distributor 106 may normally charge the advertiser one dollar per click-through. When the visitor 108a clicks-through the ad 112b of the low-quality page 110b, the compensation distribution module 120 may cause the advertiser 104 to be charged the conventional amount of one dollar, but only compensate the publisher 102b a lesser portion (e.g., seventy-five cents). The remaining amount (e.g., twenty-five cents) may be stored in, for example, a fund 124. When the visitor 108a clicks-through on the ad 112a, the compensation distribution module 120 may cause the advertiser to be charged the conventional one dollar, and compensate the publisher 102a a greater amount (e.g., one dollar and twenty-five cents) by paying the publisher 102a with the advertiser's 104 one dollar, plus a remainder above that amount (e.g., twenty-five cents) drawn from the fund 124.

FIG. 2 shows a flow diagram of an example process 200 for performing compensation distribution. The process 200 starts at a step 202. The process 200 can be started manually (e.g., initiated by a user) or automatically (e.g., as a scheduled process, in response to a request from another process). At a step 204, a classifier such as the classifier module 122 of FIG. 1 can be trained. In some implementations, the classifier can be trained to evaluate one or more aspects of one or more pages (e.g., the pages 110a-110b), including the pages' authoritativeness, verifiability, entertainment value, grammatical accuracy, educational value, timeliness, aesthetic quality, originality, cohesiveness, reputation, informational value, search ranking, popularity, server responsiveness, or other quality criteria and/or combinations thereof, to name a few examples.

In some implementations, classifiers can be trained using one or more templates. For example, templates for the most commonly used page designs available in the network (e.g., on the internet) can be developed. The classifier can use the template to determine whether a page at issue uses the common page design, which can be considered a quality aspect. As another example, a template of a known “bad” page design can be used.

In some implementations, the classifier can be trained to look for any concepts that can be identified on the page, such as by parsing text from the page or by any other suitable technique. In some examples, a library of predetermined concepts to look for can be provided to the classifier. The classifier can be trained to evaluate the concepts in one or more ways. For example, the classifier can determine whether there are few or many concepts on the page, which can be used as a quality criterion.

At an optional step 206, an auction can be conducted. In some implementations, the auction may be conducted to determine which ads will be provided to one or more publishers for inclusion in the publishers' pages. Quality scores can be taken into account in auctions. For example, the publisher 102a can have a better reputation than the publisher 102b for publishing relatively higher-quality pages (e.g., the page 110a). In this example, one or more advertisers such as the advertiser 104 can compete for advertising space by offering various amounts of money to place their ads on the publisher's 102a pages.

In some implementations, publishers can compete for rights to publish content such as ads at the optional step 206, for example by submitting bids for ads in an auction. For example, the publishers can submit bids which represent percentages of the revenue share they seek for publishing the ad/content. Assume, for example, that the publishers 102a and 102b submit competing bids, the publisher 102a seeking a lower percentage of an ad revenue share than the publisher 102b. In this example, the publisher 102a wins the auction with a lower bid, and ads can be provided to the publisher 102a at the submitted revenue rate. In some implementations, quality scores can be taken into account in auctions as well. For example, assume that the publisher 102a submits a lower bid than the publisher 102b, and that the quality score (e.g., based on reputation) of the publisher 102b is higher than that of the publisher 102a. In some implementations, the higher quality score can offset the lower value of the publisher 102a's bid.

At a step 208, a content such as the page 110a can be identified to the classifier module. In some implementations, the content can be identified by selecting it from a collection of known content, such as a database of pages or page addresses. The classifier can identify the content or it can be identified to the classifier by another component. In some implementations, the content can be identified by detecting the address of a page that includes ads. For example, the page 110a can include an ads applet, and when the page 110a is published the applet may be executed to request ads from the ad distributor 106. The ad distributor 106 can then use the address of the request to identify the page 110a to the classifier module 122. In some implementations, the content can be identified through a search engine. For example, a search engine can catalog information about one or more pages, including data that can indicate that the page includes ads. The search engine can be queried to determine one or more pages that include ads, and can identify one or more of those pages to the classifier module.

At step 210, the quality of the page can be analyzed according to a quality criterion. In some implementations, the quality of the page can be analyzed using the classifier trained in the step 204. At a step 212, the quality of the page can be associated with a quality score. In some implementations, the quality score can be a relative score within a predetermined range. For example, quality scores can range from a value of 0.0 to a value of 1.0, and a page of average quality can be given a score of 0.5. In another example, quality scores can range from a value of 0 to a value of 100, and a relatively high quality page can be given a score of 95. In some implementations, the quality scores can be a cumulative score. For example, the classifier module can add a point to a page's quality score for every detected “good” aspect of the page (e.g., a working link, a verifiable fact) and/or subtract a point for every detected “bad” aspect of the page (e.g., broken link, misspelled word). Other types of scoring can be used.

At and optional step 214, the analyzed page's publisher can be informed of the quality score associated with the page. For example, informing the publisher about the quality score can promote the creation of high quality pages. For example, the publisher 102a can use the quality score to compare the quality of the page 110a to other pages that may be published by the publisher 102a to identify pages that can be edited to improve their quality. In another example, the publisher 102a can compare a quality score determined before the page 110a was edited to a quality score determined after the page 110a was edited to determine quantitatively how the edits may have affected the page's 110a quality.

At step 216, content such as advertising can be forwarded (or otherwise provided) to the publisher to be published with the page's content. In some embodiments, content can be forwarded to the publisher in a substantially dynamic manner. For example, a substantially random subset of a collection of ads may be published with a page when the page is served, therefore a different subset of ads may be published each time the page is served and/or refreshed. At step 218, information about the page, content, the relationships between the two and/or other information can be recorded. For example, the identity of the page 110a, the page's 110a quality score, the identity of the ad 112a, and the date and time of when the content was forwarded can be recorded.

In some implementations, the page's quality score can be analyzed after the ad content has been forwarded. For example, the page's 110a content may change frequently (e.g., a news page, an online auction page, a blog) and the page's 110a quality may also change frequently. In this example, the quality score of the page 110a may not be known when the ad 112a is forwarded to the publisher 102a at the step 216, so a record of the page's 110a identity, the ad's 112a identity, a time and date stamp, and/or other information can be recorded at the step 218. The recorded information can be used at a later time to identify the page 110a to the classifier module 122 and analyze the quality of the page 110a (e.g., the steps 208-210), and the quality score can be added to the information recorded at the step 218.

At step 220 a fee can be determined. In some implementations, the fee can be an amount of money that an ad distributor can charge the advertiser for placing the ad on the page. In some implementations, the amount of the fee can be adjusted based at least partly on the quality score associated with the page. For example, the ad distributor 106 can charge one dollar for each ad that is placed on the pages of average and/or high quality (e.g., pages with a score of 0.5 or better on a scale of 0.0 to 1.0), but charge only sixty cents for each ad placed on a page of relatively lower quality (e.g., a score of 0.25). In some implementations, the amount that is charged can be at least partly proportional to the score associated with a page when the ad was placed. For example, the ad distributor 106 can charge one dollar for placing an ad 112a on the page 110a with a score of 1.0/1.0, and charge $0.75 for placing the ad 112b on the page 110b with a score of 0.75/1.0. At a step 222, the fee is collected from the advertiser 104.

At a step 224, an amount of compensation can be determined. In some implementations, the amount of compensation can be the amount of money that the ad distributor pays out to the publishers for publishing ads. In some implementations, the amount of compensation can be at least partly determined based upon the quality score of the page on which the ad was placed. For example, the ad distributor 106 can pay the publisher 102a fifty cents for each ad placed on pages of relatively high quality, and can pay twenty five cents for each ad placed on pages of relatively lower quality. At a step 226, the compensation that was determined at the step 224 can be distributed.

As indicated, some publishers can receive a lower compensation if a quality score is considered low. This can be considered as withholding compensation from that publisher. In some implementations, compensation that is withheld from one or more publishers can be kept in a fund, such as the fund 124. In some implementations, the compensation can be distributed by a compensation distribution module, such as the compensation distribution module 120.

At the step 228, the compensation can be shared, for example with the advertiser. In some implementations, compensation can be withheld from publishers and some or all of the withheld amount can be used to reduce the amount of money charged to the advertiser. For example, the advertiser 104 can be charged a dollar for placing the ad 112b on the page 110b, and later it can be determined that the page 110b is of relatively low quality. In this example, the publisher 102b can be given a reduced amount of compensation for placing the ad 112b, and the ad distributor 106 can reduce the overall amount of money charged for placing the ad 112b.

At a step 230, compensation can be withheld from one publisher and shared, such as with another publisher. For example, the ad distributor 106 can normally pay the publishers 102a-102b one dollar for each ad 112a-112b placed on a page of relatively average or high quality, such as the page 110a. The ad distributor 106 can determine that the page 110b is of relatively low quality, and pay the publisher 102b $0.75 for placing the ad 112b. The content provider 106 can use the $0.25 withheld from the publisher 102b to increase the amount paid to the publisher 102a to $1.25 (e.g., the regular one-dollar payment plus the $0.25 withheld) for placing the ad 112a.

The page's quality is analyzed again at a step 232, and the page is associated with a new quality score at the step 234. In some implementations, the step 232 may be omitted in favor of the step 210. In some implementations, a page's quality score can be reanalyzed and associated on a periodic interval. For example, the page 110a can be re-analyzed once a day, week, month, or other period of time. In some implementations, the interval in which the page is reanalyzed can be different from the interval in which the new quality scores are associated with the page. For example, the page 110a can be reanalyzed weekly, but the quality score used to determine the fees paid and/or collected can be updated once per month.

In some implementations, two or more quality scores determined at different times can be combined to determine a quality score that may be used for collecting and/or distributing compensation. For example, the content and quality of the page 110a can change on a daily or weekly basis; therefore, the quality scores determined for the page 110a can fluctuate when reanalyzed on a weekly interval. The ad distributor 106 can combine multiple weeks' scores (e.g., an average of the last four weeks' scores, a weighted average of the last six weeks scores, a statistical median of the last 52 weeks' scores) to determine a quality score that can be associated with the page 110a.

At a step 236, the new quality score can be compared with the old quality score. In some implementations, the new and old quality scores can be compared to determine if the page's quality has increased or decreased. In some implementations, the publisher can be informed of the comparison. For example, the ad distributor 106 can compare the new quality score and the old quality score of the page 110a, and can provide the publisher 102a with information about the relative improvement or loss of quality in the page 110a. The process 200 can end at a step 238.

In some implementations, the process 200 can include more or fewer steps. As another example, one or more steps can be performed in a different order.

Although previous implementations have described various implementations of compensation distribution for electronic data (e.g., web pages, streaming media, news feeds), other implementations can exist. In some implementations, the pages 110a-110b of FIG. 1 can be printed materials, such as newspapers, magazines, or other forms of publications. For example, the ads 112a-112b can be printed ads that are placed in a magazine. The magazine's quality can be evaluated and given a quality score, and the quality score can be used to determine amounts of compensation that can be paid to the magazine's publisher, and/or the amount of money the advertiser can be charged for printing the ads.

In some implementations, the pages 110a-110b can be television programs, radio programs, movies, or other forms of media. For example, the ads 112a-112b can commercials in a television or radio program, or advertisements shown during a movie preview, to name a few examples. The quality of the media can be evaluated to determine a quality score, and the score can be used to determine the amount of money an advertiser can be charged, and/or the amount of compensation that can be paid to the entity that presented the media (e.g., the television network, radio station, movie theater).

In some implementations, the pages 110a-110b may be events, such as sporting events, festivals, concerts, or parades, to name a few examples. In these implementations, the ads 112a-112b can be banners, billboards, announcements, or other forms of advertisements that can be used during an event. The quality of the event can be evaluated to determine a quality score. For example, a sporting event that is “exciting,” well-played, or well-attended can be given a high quality score, whereas an event that is rained out, poorly played, or “boring” may be given a low quality score. The quality scores can be used to determine the fees that the advertiser 104 can be charged, and/or to determine the amount of compensation that can be paid to the stadium, the teams, and/or the participants.

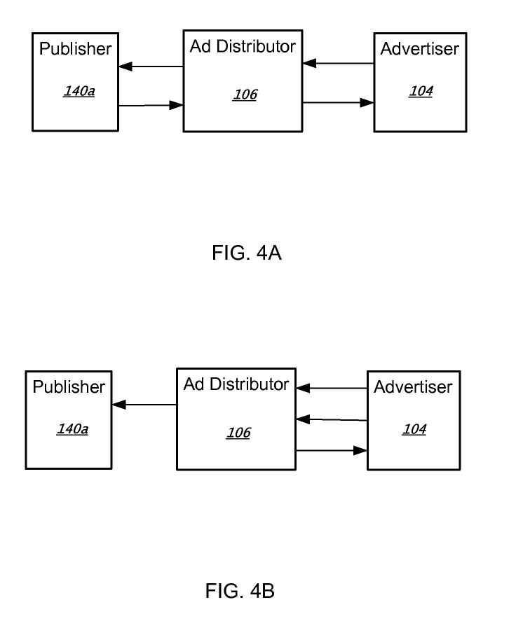

FIGS. 4A-B show examples of compensation distribution. FIG. 4A shows a system 400 that can perform just-in-time compensation distribution. The system 400 can include the advertiser 104, the ad distributor 106 and the publisher 140a, to name a few examples. Here, the ad distributor 106 can receive a plurality of bids as indicated by arrow 402. The bids can come from the advertiser 104 and others, and are for presenting content such as an ad in a publication resource, for example a page controlled by the publisher 140a. The ad distributor 106 can select at least one of the plurality of bids. For example, the highest bid can be selected.

The ad distributor 106 can determine a quality score for the publication resource substantially at a time coincident with presentation of the content in the publication resource. The presentation of the content in the publication resource is indicated by arrow 404; determination of the quality score is indicated by arrow 406. In some implementations, the quality score can be determined using the classifier module 122.

The ad distributor 106 can adjust the selected bid based on the quality score. For example, an amount of the selected bid can be adjusted up or down based on the quality score. Adjustment of the bid is indicated by arrow 408.

In FIG. 4B, the ad distributor 106 can receive a plurality of bids as indicated by arrow 402, and select at least one of the plurality of bids. The ad distributor 106 can determine a quality score for the publication resource as indicated by arrow 406 and collect a bid amount for the selected bid as indicated by arrow 410. Moreover, the ad distributor 106 can generate a refund of a portion of the bid amount based on the quality score, here indicated by arrow 412. For example, a smaller or larger refund can be generated based on the quality score.

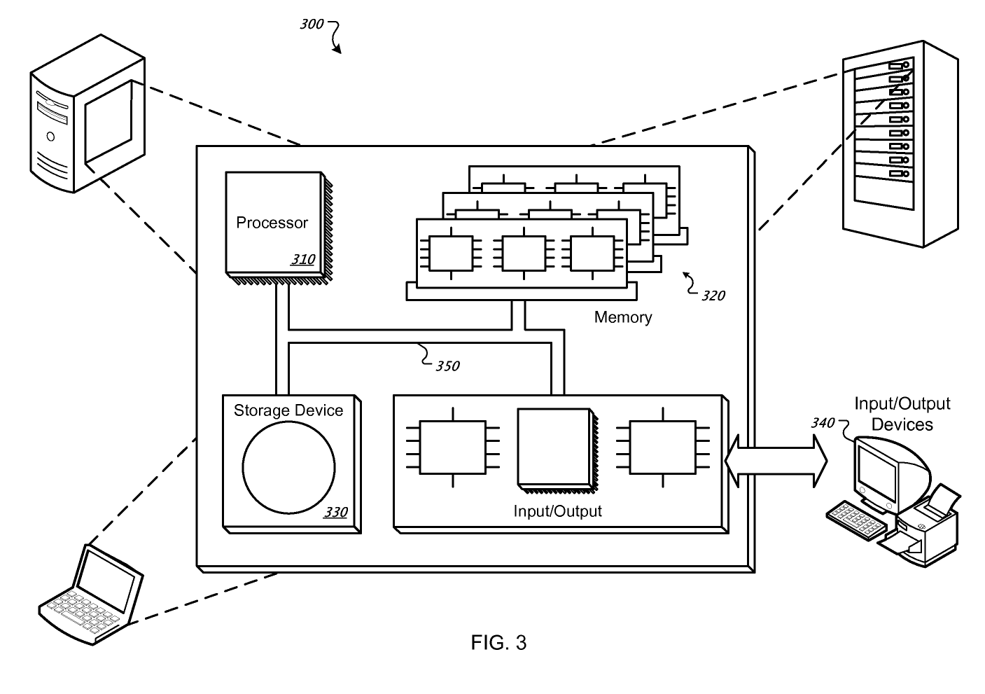

FIG. 3 is a schematic diagram of a generic computer system 300. The system 300 can be used for the operations described in association with any of the computer-implement methods described previously, according to one implementation. The system 300 includes a processor 310, a memory 320, a storage device 330, and an input/output device 340. Each of the components 310, 320, 330, and 340 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 may be a floppy disk device, a hard disk device, an optical disk device, or a tape device.

The input/output device 340 provides input/output operations for the system 300. In one implementation, the input/output device 340 includes a keyboard and/or pointing device. In another implementation, the input/output device 340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for compensation distribution, the method comprising:
analyzing first content from a publisher with regard to a quality criterion;
associating the first content with a quality score based on the analysis;
providing second content to the publisher to be published with the first content; and
distributing a compensation to the publisher relating to the second content, the compensation based at least in part on the quality score.

2. The computer-implemented method of claim 1, wherein an advertiser provides the second content for forwarding to the publisher, further comprising:
collecting a fee from the advertiser for publishing the second content, wherein distributing the compensation to the publisher includes sharing a portion of the fee with the publisher based on the quality score.

3. The computer-implemented method of claim 2, further comprising:
determining the fee to be collected from the advertiser, the fee determined based at least in part on the quality score.

4. The computer-implemented method of claim 1, wherein a content distributing entity forwards the second content to the publisher and distributes the compensation, and wherein distributing the compensation includes that the content distributing entity gains a higher sum compared to an equivalent publication by another publisher associated with a higher quality score that the publisher.

5. The computer-implemented method of claim 4, further comprising:
sharing at least part of the higher sum with an advertiser who pays to have the second content published.

6. The computer-implemented method of claim 4, further comprising:
sharing at least part of the higher sum with the other publisher having the higher quality score.

7. The computer-implemented method of claim 1, further comprising:
again analyzing the first content with regard to the quality criterion; and
associating the first content with a new quality score based on again analyzing the first content.

8. The computer-implemented method of claim 7, further comprising:
informing the publisher, before the first content is again analyzed, about a quality of the first content; and
comparing the new quality score with the quality score to determine whether the quality has improved.

9. The computer-implemented method of claim 7, wherein the first content is associated with the new quality score every n time units and wherein the new quality score is based on analyses of the first content over a past N time units, wherein n and N are positive numbers.

10. The computer-implemented method of claim 1, wherein the second content is forwarded to the publisher in real time for publication, further comprising:
recording information about the first content, second content and the quality score in connection with forwarding the second content; and
determining the compensation based on the recorded information, the compensation determined subsequently and substantially not in real time.

11. The computer-implemented method of claim 1, further comprising:
conducting an auction for the publication of the second content with the first content, wherein the compensation is based also on an outcome of the auction.

12. The computer-implemented method of claim 11, wherein the auction is arranged so that a plurality of publishers compete for rights to publish the second content.

13. The computer-implemented method of claim 1, wherein analyzing the first content comprises:
training a classifier module to perform analysis regarding at least the quality criterion; and
identifying the first content to the classifier module to perform the analysis.

14. A computer program product tangibly embodied in a computer-readable storage medium and comprising instructions that when executed by a processor perform a method for compensation distribution, the method comprising:
analyzing first content from a publisher with regard to a quality criterion;
associating the first content with a quality score based on the analysis;
forwarding second content to the publisher to be published with the first content; and
distributing a compensation to the publisher relating to the second content, the compensation based at least in part on the quality score.

15. A computer system comprising:
a repository including quality scores for respective first contents associated with publishers, the quality scores determined by analyzing the first content with regard to a quality criterion;
a content distribution module that forwards second content to at least a first one of the publishers to be published with at least one of the first contents; and
a compensation distribution module that distributes a compensation to the first publisher relating to the second content, the compensation based at least in part on the quality score of the first publisher.

16. A computer-implemented method for compensation distribution, the method comprising:
analyzing a first page from a publisher with regard to a quality criterion, the publisher having agreed to include at least one advertisement on the page in return for compensation;
associating the first page with a quality score based on the analysis, the quality score indicating a quality of the page as defined by an advertisement serving entity who serves at least the advertisement to the publisher;
obtaining at least the advertisement from an advertiser who has agreed to pay a fee for publication of the advertisement;
forwarding at least the advertisement to the publisher to be published on the first page, the advertisement selected by the advertisement serving entity; and
distributing a payment to the publisher relating to the advertisement, the payment being calculated based at least in part on the fee received from the advertiser and the quality score, wherein a remainder of the fee is at least temporarily kept by the advertisement serving entity.

17. The computer-implemented method of claim 16, further comprising:
sharing at least part of the remainder with the advertiser.

18. The computer-implemented method of claim 16, further comprising:
identifying at least one other publisher having a higher quality score than the publisher; and
sharing at least part of the remainder with the other publisher.

19. A method comprising:
receiving a plurality of bids for presenting content in a publication resource;
selecting at least one of the plurality of bids;
determining a quality score for the publication resource substantially at a time coincident with presentation of the content in the publication resource; and
adjusting the selected bid based on the quality score.

20. A method comprising:
receiving a plurality of bids for presenting content in a publication resource;
selecting at least one of the plurality of bids that indicates a bid amount;
collecting the bid amount for the selected bid;
determining a quality score for the publication resource substantially at a time coincident with presentation of the content in the publication resource; and
generating a refund of a portion of the bid amount based on the quality score.
